(19) United States
(12) Patent Application Publication
(10) Pub. No.: US 2003/0225849 A1
(43) Pub. Date: Dec. 4, 2003

(54) Network system for handling electronic newsletters and e-zines

(76) Inventor: Barry Friedman, Potomac, MD (US)

Correspondence Address: NATIONAL IP RIGHTS CENTER, LLC, SCOTT J. FIELDS, ESQ., 550 TOWNSHIP LINE ROAD, SUITE 400, BLUE BELL, PA, 19422, US

(21) Appl. No.: 10/345,111

(22) Filed: Jan. 15, 2003

Related U.S. Application Data
(63) Continuation-in-part of application No. 10/007,318, filed on Nov. 5, 2001.

(51) Int. Cl. G06F 15/16

(52) U.S. Cl. 709/207

(57) ABSTRACT

The present invention is specifically directed to a system for generating directed emails and ezines based upon the input of a sponsor and the desires of an end user. The email system provides email based newsletters and ezines which incorporate content, announcements and which facilitate the creation of teams and tasks. The system is controlled by a comprehensive administrative system.

### FIELD OF THE INVENTION

The present invention is directed to online computer systems. In particular, the present invention is specifically directed to online computer systems that can be used to handle the creation, management and distribution of newsletters, magazines and ezines.

### BACKGROUND OF THE INVENTION

The Internet or World Wide Web is one of the most critical technological developments of the last 10 years. The Internet has provided vast economic opportunities for numerous businesses and industries to vastly expand the number and quality of their services. One of the earliest and fastest emerging areas of Internet activity has been in providing rapid, up-to-the-minute business information. To date, a number of patents have issued on Internet related systems that cover a wide array of business information and electronic commerce (e-commerce) applications. One of the fastest areas of growth has been in the area of online business information and email communications.

There have been a number of prior systems which relate to Internet email and the like. U.S. Pat. No. 5,937,162 is directed to a method and apparatus for high volume e-mail delivery. This system incorporates a high volume e-mail “newspaper” delivery system which contains for each customer a personal configuration file, and further contains the information resources that the customer would like emailed to his desktop. The configuration file is highly customizable allowing the end-user detailed control over the content format and timing of the delivered emails.

U.S. Pat. No. 6,026,368 is directed to a system for prioritizing queues of advertising and content in which content data is generated by a queue holder and sent to an online queue manager. A computer mediated communications network provides content and subscriber data to the queue builder and receives content segment from the online queue manager.

U.S. Pat. No. 6,047,310 is directed to an information disseminating apparatus for automatically delivering information to suitable distributees is directed to a receiver for advertisement information. The sender registers an advertisement transmission requirement to the distribution host computer through a sender terminal. The host computer references receiver attributes and desired categories that the advertisement recorded in the advertisement reception requirement in categories and desired attributes for the receivers recorded in the advertisement transmission and generates a distribution list that satisfies both desire of the receiver and of the sender.

There are a substantial number of additional email systems throughout the Internet. While there have been a large number of email based messaging, newsletter and ezine systems throughout the Internet, there has been a long felt need for systems which facilitate email communication based upon sponsor generated or approved content. There is an ongoing need for systems and technologies for providing online emails and the ability to provide optimized content.

There is a further need for knowledge-based email delivery systems which are applicable to a wide range of specialty areas and which can be used to generate a plurality of newsletter type content in a wide range of specialty areas.

It is therefore a principal object of the present invention to provide a knowledge based email and newsletter system that can be utilized for law, accounting, engineering or any other endeavor or field of specialty. It is a further object of the present invention to provide for a system which can provide automatic article rotation and which can facilitate the choice of article categories by the end user.

There is a further need for a system that can provide and create customized email driven newsletters dynamically including announcements by the sponsor. It is a further object of the present invention to provide an email driven newsletter in which banner ads can be placed and rotated based upon the needs and desires of a sponsoring entity.

It is a further object of the present invention to provide a system which facilitates exclusive content channels.

It is another object of the present invention to provide a system in which the address email firm button and announcement heading can be unique.

It is a further object of the present invention to provide a system providing a comprehensive reporting system.

It is a further object of the present invention to provide a system that can facilitate a multiplicity of channels.

It is a further object of the present invention to provide a system including an audio enabled library.

It is a further object of the present invention to provide a mechanism whereby the email contact point can be altered.

It is still a further object of the present invention to provide an email notification system in which welcome letters can be segregated by number.

These and other objects of the present invention will become apparent from the detailed description and from the following summary, detailed description and claims.

### SUMMARY OF THE INVENTION

The present invention is specifically directed to a system for generating directed emails and ezines based upon the input of a sponsor and the desires of an end user. The email system provides email based newsletters and ezines which incorporate content, announcements and which facilitate the creation of teams and tasks. The system is controlled by a comprehensive administrative system.

In accordance with the present invention, a system for creating and managing a communication between a sponsor and an end user comprising a control unit for establishing a newsletter communication; means for assisting an end user in formulating a newsletter request based upon the desires of the end user; and means for distributing the newsletter to the end user.

In a further embodiment, the invention comprises a system for creating, editing and managing email newsletter communications in a specialty area between a sponsor and an end user: a control unit for generating a newsletter based upon the inputs of the sponsor, said newsletter providing a plurality of content items; means for emailing the newsletter to the end user; means for permitting the end user to define new types of content the end user desires to receive; means for the end user to define tasks within the system based upon the content of the newsletter; and means for the end user to invite other end users to receive the newsletter.

In still a further embodiment of the present invention, the invention is directed to a system in which email newsletters can be sent out to exclusive lists of clients for a particular sponsor. In a further embodiment, the sponsor can control elements such as the address, email firm button and announcement heading.

In still another embodiment, the invention provides a comprehensive reporting system and a plurality of channels. The system may also be audio enabled.

### BRIEF DESCRIPTION OF THE FIGURES

FIG. 1 is a block diagram of the present invention.

FIG. 2 is a block diagram of the database of the present invention.

FIG. 3 is a diagram of the database of the present invention.

FIGS. 4 to 24 illustrate a series of input screens for use by clients in conjunction with a legal request for proposal generation system in accordance with the present invention.

### DETAILED DESCRIPTION OF THE PREFERRED EMBODIMENT

The present invention is directed to a system for creating, managing and distributing newsletters, e-zines and similar communications over a communication network using, for example, personal computers and similar devices. In particular, the present invention is directed to a system for providing newsletters and ezines which can be constructed and controlled based upon the desires or needs of a sponsor or an end user.

While the present invention is being described in the context of a system using a personal computer, the configuration of the end user device is not critical to the present invention. The present invention may be used with any system that connects to the Internet or uses other IP transport methods. The end user device can comprise any end user device which can connect to a network such as a wireless device, palm pilot, PDA, end user work station or hand-held device.

In a most preferred embodiment, the present invention is directed to a system for creating, publishing and editing online newsletters, e-zines and the like. Over the past fifteen (15) years, personal computers have become relatively powerful and inexpensive and have gained widespread use in a significant number of homes and businesses. With a modem, personal computers can communicate with other computers through communication networks and access many resources on the so-called “Information Super Highway.” Companies such as America Online, CompuServe and Prodigy, which traditionally provided so-called “content” over proprietary networks, have begun to provide access by personal computer users to an expansive international network of computer networks known as the Internet.

As is well known by those skilled in the art, the World Wide Web is a graphical sub-network of the Internet. With common “Web Browser” software such as Mosaic, Netscape Navigator, or Microsoft Explorer, end users may easily access Internet information and services on the World Wide Web. A web browser handles the functions of locating and targeting information on the Internet and displaying the information provided by the Web Server. The World Wide Web utilizes technology called “Hyper-Text” to organize, search and present information on the Internet. Using a web browser, the end user can select a word (“Hyper-Text word”) from a view document and be linked to another document featuring information related to the word.

The present invention is broadly directed to a computer network for distributing information regarding the placement and creation of newsletters and e-zines for a wide variety of professional related information. The present invention is designed, in one embodiment, to be utilized on the World Wide Web or Internet, although the present invention is equally applicable to other network environments. As noted above, the present invention is similarly related to user interfaces which are not computers such as palm pilots, wireless and cellular devices.

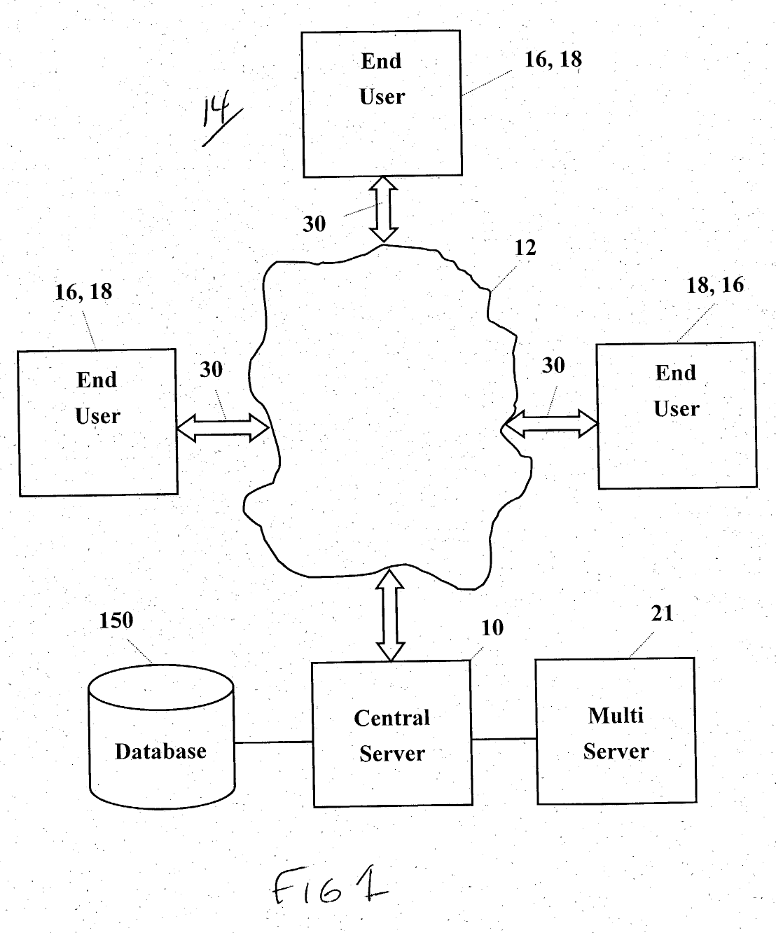

Referring to FIG. 1, the operational background and structures of a most preferred embodiment of the present invention is disclosed and shown. The most preferred embodiment comprises a central computer server 10 connected by a computer network 12 to remote end user stations 14. The central server connects to a database 150. In a preferred embodiment, end user stations 14 comprise a plurality of end users 16, 18. End users 16, 18 are defined herein as individuals linked to the system who may compromise sponsors, members, affiliates and advertisers who utilize the system.

For purposes of this disclosure, a sponsor is an organization which creates or uses the ezine creation, management and distribution system of the present invention to provide content and other applications for end users which may be clients, prospective clients or referral sources. Users 16, 18 are linked with the central computer server 10 via a transport medium 30. End users 16, 18 will typically comprise employers and employees who, in a most preferred embodiment, will be linked via a global computer network 12 such as the Internet or Worldwide web, but other embodiments including LANs, WANs and Intranets, fulfill the spirit and scope of the present invention.

The end user devices 16, 18 will typically comprise any device that connects to the system via the Internet or other IP transport methods and includes, but is not limited to, such devices as televisions, computers, hand-held devices, cellular phones, land based telephones, wireless electronic devices and any device which uses a transport medium 30. Non-limiting examples of a transport medium 30 applicable for use in the present invention comprise any backbone or link such as an ATM link, FDDI link, satellite link, cable, cellular, twisted pair, fiber optic, broadcast wireless network, the internet, the world wide web, local area network (LAN), wide area network (WAN), or any other kind of intranet environment such a standard Ethernet link. In such alternative cases, the clients will communicate with the system using protocols appropriate to the network to which that client is attached. All such embodiments and equivalents thereof are intended to be within the scope of the present invention.

Referring again to FIG. 1, the present invention may comprise a multi-server 21 environment which comprises a computer system in accordance with the present invention that allows the multiple end users 16, 18 to communicate with the system and system clients. Through communication link and transport medium 30, end users 16, 18 will send data which must be correctly identified and confirmed and who are linked to the central server 12, preferably by a customizable interface to be described in greater detail below.

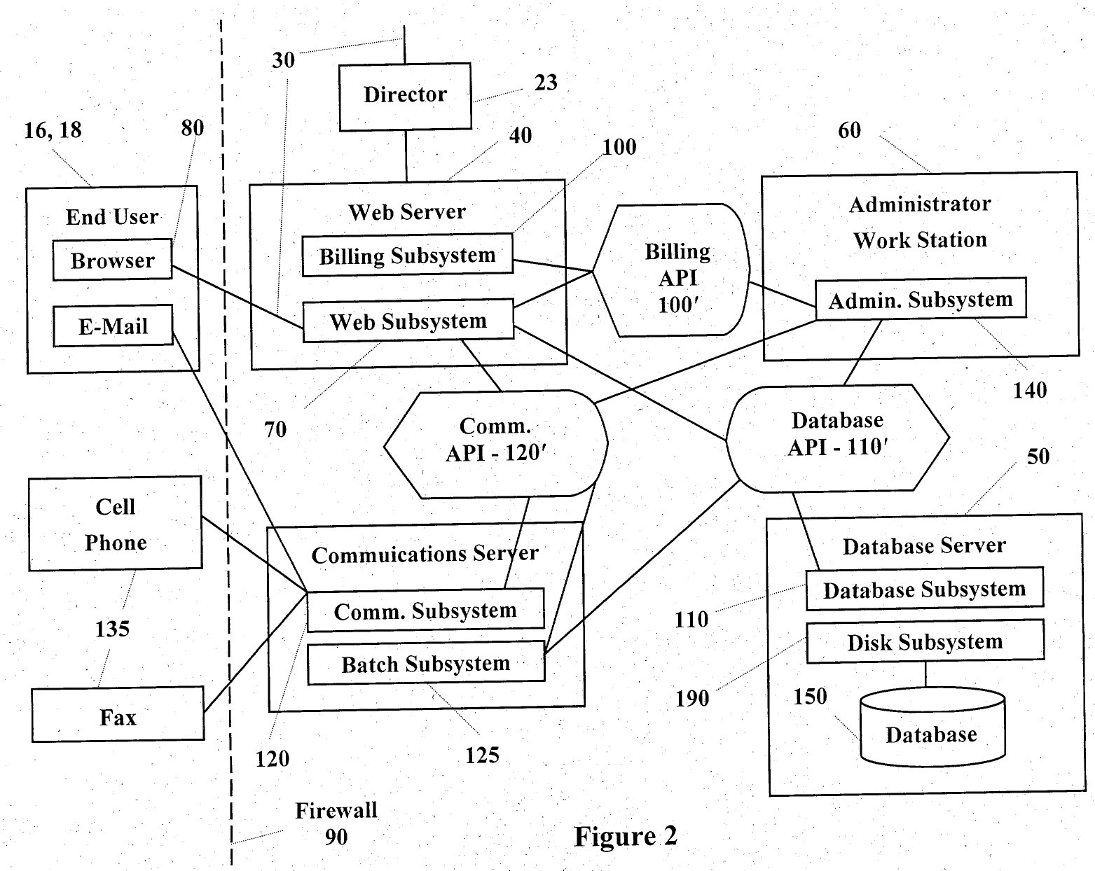

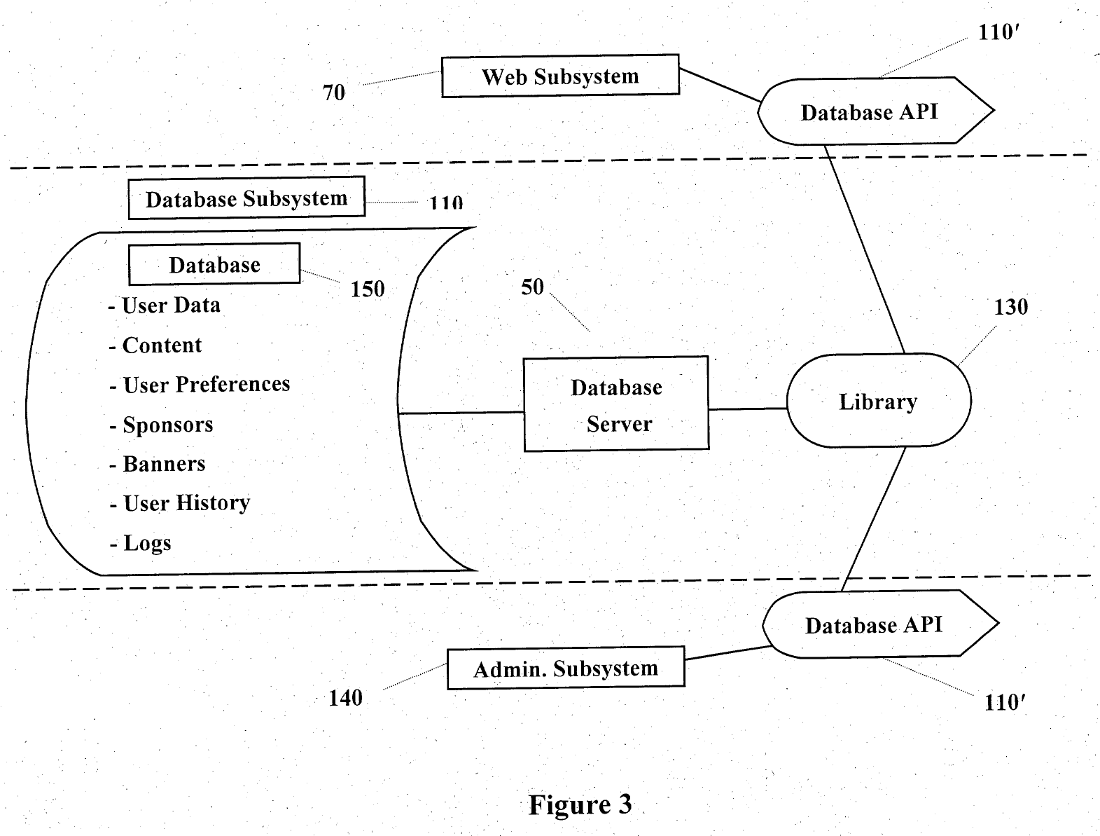

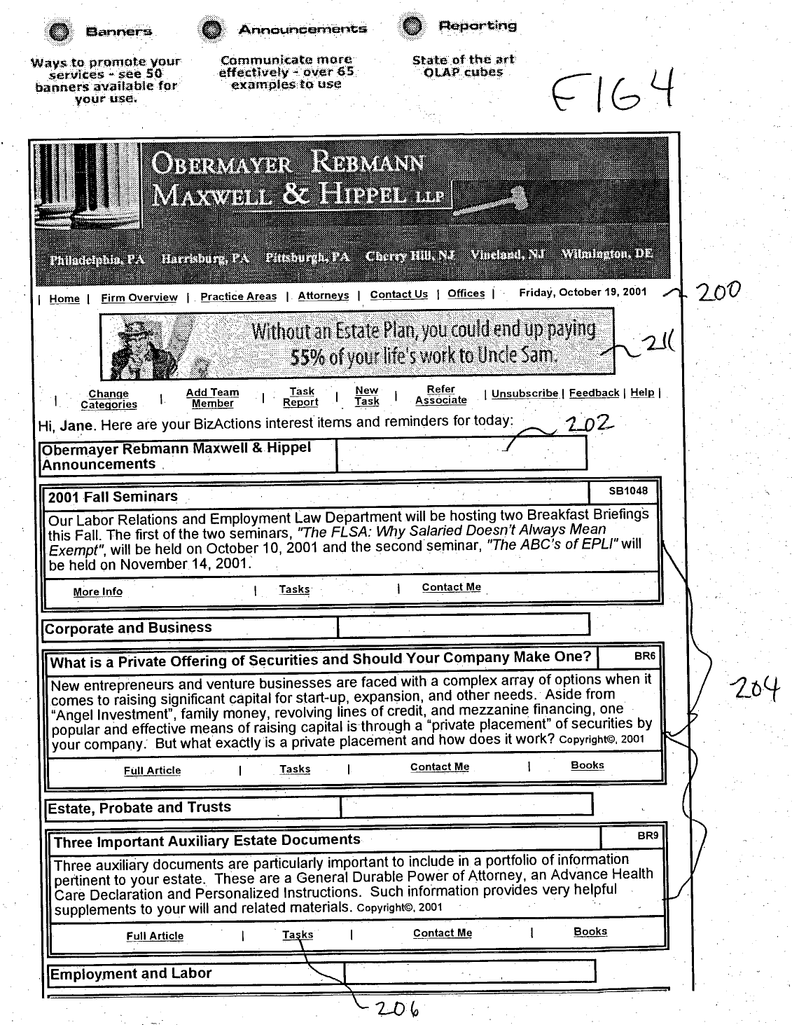

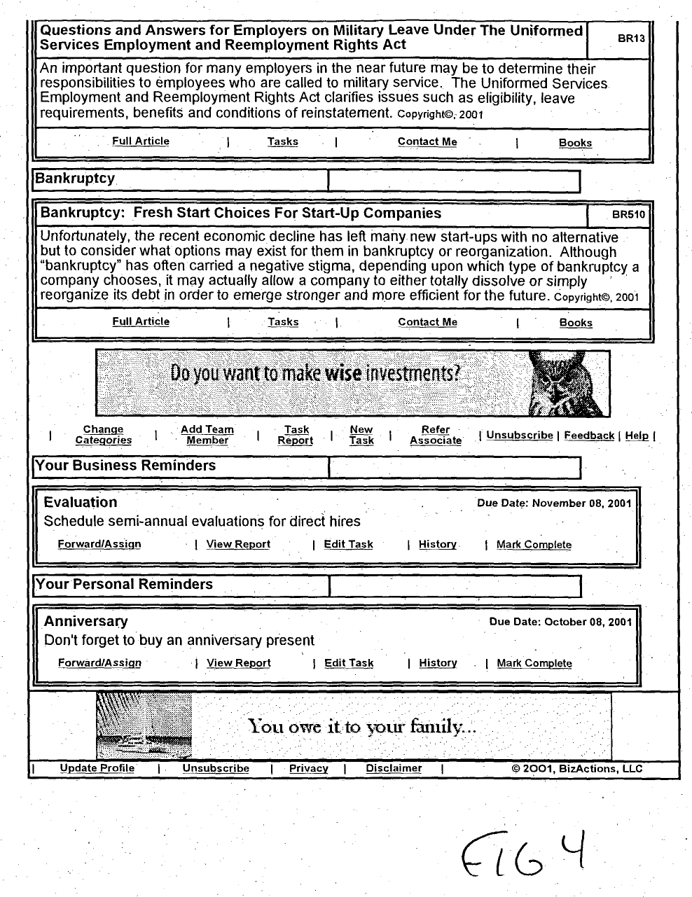

Referring to FIGS. 2 and 3, the central server and database systems of the present invention are now shown and described in greater detail. A local director 23 routes signals through the system to the various servers, to be described below, and to and through transport medium 30 to end users 16, 18. The system preferably includes two primary servers, a web server 40 and a database server 50 which may operate using such database platforms as SQL server, Oracle or Linux. Alternatively, the server can further comprise an Oracle, Microsoft, Linux database server. The system further includes an administrative workstation 60 or system which provides the administrative capabilities and monitoring for the system under the control of an administrative subsystem 140. The administrative work station 60 allows administrators or other operators to perform routine operations which affect the entire system. Such operations include, but are not limited to, administering the accounts of end users 16, 18 monitoring the traffic through the system, the tabulating of user printing reports, the updating of end use, the performing of backups and maintaining the programs that comprise the overall system.

A web subsystem 70 is responsible for all interactions with a web browser 80 in the end user devices 16, 18 and serves as the end user interface to the system. All interactions between the end user devices 16, 18 and the database subsystem occur through the web subsystem 70. Internet Information Server 200 (IIS) by Microsoft Corporation is an exemplary web server software system 70 in accordance with the present invention, although the present invention is in no way limited to this system. The expression of the user interface presented to end user 16, 18 in their client devices may be implemented as HTML or other high level computer language or technology, and may be displayed in a standard web browser. Typically, the interface will be presented as a website presentation such as WWW.BIZACTIONS.COM including an administrative back end section and application which provides full control over newsletter generation and the addition of new sponsoring entities among other functions.

All systems listed above are preferably communicated via an Ethernet 100 base T network and a switching hub. In addition, a second isolated network segment will preferably exist between the web server 40 and the external communications hardware (e.g. internet router). Such a system will keep external traffic isolated from the internal network, as well as provide a dedicated connection between the web server 40 and the Internet for maximum throughput. The systems will have an initial configuration of random access memory for the web server 40 and preferably at least 128 megabits for the database server 50, both having the capability to expand.

The web server 40 is the point of entry to the entire system. The system determines the identity of the users 16, 18 and makes appropriate decisions while serving web pages to the end users 16, 18. The web server 40 sends HTML or other high level computer language to the end user work stations 16, 18, validates passwords, sends logging and transaction information to the database server 50, and performs logical operations, thus behaving as a transactional server.

As noted above, in one embodiment, the server operating system may be a Windows NT server, a multi-platform operating system provided by Microsoft Corporation. The Sun Microsystems Solaris or Linux is an alternative embodiment. The server typically includes IIS, which is a completely integrated Internet application platform. IIS includes a high-performance web server, an application development environment, integrated full-text searching, multi-media streaming and site management tools. The security infrastructure is integrated within the server, thus enabling an easy-to-maintain and highly-secure web development and deployment environment.

The operators of the system may create, delete and update account information by utilizing the administrative subsystem 140 in administration work station 60. A billing subsystem 100 is used for crediting and debiting end user keyer accounts. As will be discussed below, end user keyers 16, 18 will typically receive remuneration of some manner for participating in the system including cash or other premiums.

Database 110, communication 120 and billing 100 subsystems thus execute essential services for the other parts of the system, and will therefore have well-defined application program interfaces (API) 110′, 120′, 100′, as is well recognized by those with skill in the art. The system will preferably be protected for the Internet by a “firewall” 90 which is a safety precaution, and important with respect to the present invention due to the sensitive and confidential nature of the information in the database. As will be discussed below, firewall 90 plays an important and critical role in the present invention because of the confidentiality of the data associated with some applications of the present invention.

In a preferred embodiment, the database subsystem 110 stores all pertinent information pertaining to user accounts, administrator accounts, payment and remuneration parameters, as well as general dynamic system information. All interactions with the database subsystem 110 are performed through a database API 110′ which may define the interface to a library of stored procedures 130. These are used to implement high-level database functions and to shield the details of the database implementation from the other subsystems. The database subsystem 110 is preferably implemented using database server 50.

The administration subsystem 140 provides an interface for operators and managers of the system to modify the database, print reports, view system data and log user comments and complaints. The administration subsystem 140 provides a collection of access forms, queries, reports and modules to implement the administration interface. Administrators typically will have the power within the system to force most actions. The administration subsystem 140 will interact with the communications, database and billing subsystems.

The communications subsystem 120 interfaced to a communications API 120′ will be used to email and contact end users 16, 18. End users 16, 18 may be notified by phone, fax, email or pager, or other communications devices which can be contacted by the system 135. End users 16, 18 will also have a password accessed section of a website where they can access information relevant to their activities and be provided with detailed reports.

Some portable telephones and pagers include email addresses and so may be contacted by the email system; other users have only phone numbers. Other interfaces may be utilized as the application so demands.

A batch subsystem 125 may periodically send out grouped notifications. It will access the database subsystem 110 to determine what notifications are required, and uses the communication subsystem 120 to make those notifications. A group notification may comprise a special premium offered to end user keyers 16, 18. The billing subsystem 100 will be used to verify and bill credit cards and communicate through the billing API 100′ to the administration subsystem 140, and potentially to an outside billing and verification service which could be used to perform the billing functions.

Referring to FIG. 3, the database server 50 which implements the database subsystem 110 of the present invention comprises a server that maintains all associated logging and transaction information for the system. Through the database 150 (which is backed up by a backup database for safety purposes), the database server 50 logs planner and provider setup and account creation information, stores itineraries and changes made to that information, maintains user account information, maintains account balances, produces and prints reports, hosts backup operations and performs statistical calculations for the entire system.

The database server 50 is preferably a dual processor computer microprocessor. Each connection to the database 150 and its associated work may be handled by a separate thread within the database server 50 process space. It is anticipated that a dual processor machine is sufficient for the type and amount of transactions that it will be performing, however if it proves insufficient, the database can be “striped” to two or more machines to distribute the server load.

The disk subsystem 190 of the database server may comprise a vulnerable and crucial server element. Due to the mission critical design of the subsystem, it is preferable to utilize a Level 5 RAID. RAID is an alternative to standard SCSI hard disk drives. A RAID system provides automatic recovery from hard drive failures. Level 5 RAID systems provide the best balance between cost and level of data protection. A Level 5 RAID system uses multiple hard disk drives, on which the stored data is recorded redundantly using a scheme by which the data on the disk can be reconstructed if one of the disk drive units in the RAID fails. In the event of failure, the failed drive can be removed from the RAID system while it is still operating, and a replacement drive can be installed. The RAID system will regenerate the data and return itself to full protection capability. The data sorted on the disk subsystem remains available for normal processing, that is from the time the drive failures to the time the RAID system is returned to full protection capability. Other levels of RAID which are less costly do not offer this type of data availability and could translate into costly system downtime.

Statistical calculations will be performed by the database server 50, along with other types of report generation. Specifically, IIS can log directly to an Open Database Connectivity ((ODBC) standard data source. This makes the availability of the data collected by the database server about client activity on the system more readily available and easier to process into logical reports. Preferably the database server system is configured with a dual P6 CPU, 128 MB ECC, having sufficient ECC RAM, a graphics adapter capable of showing 1024×768 pixels with a depth of 8 bits, a 15 inch monitor, a PCI Fast/Wide SCSI-2 I/O adapter, one PCI 100base T Ethernet adapter, a keyboard and a mouse, a 3.5 inch floppy drive, a CD ROM Drive, a disk drive, a 2 GB PCI Fast/Wide SCSI-2 hard disk drive, two 9 GB PCI Fast/Wide SCSI hard drives (Level 1) or an 8 GB RAID Subsystem (Level 5), and a 24 GB DAT SCSI (2 MB per minute) tape back-up unit. Online reporting is performed by OLAP (online analytical processing).

As noted above, in one embodiment, there will be one operator workstation 60 used for administering the system. As the need for additional workstations arises, additional operator workstations can be added by adding additional computer systems, installing the administration software and connecting them to the LAN. Operator workstation machines preferably utilize a Windows operating environment manufactured by Microsoft Corporation.

The present invention is specifically directed to a knowledge based e-mail delivery systems. In particular, the present invention is specifically directed to a system which can be used for law, accounting, engineering or any other specialty area or discipline. It is a particular purpose of the present invention to provide a system which is a unique e-mail delivery system in which customized e-mails can be dynamically created and article rotation handled.

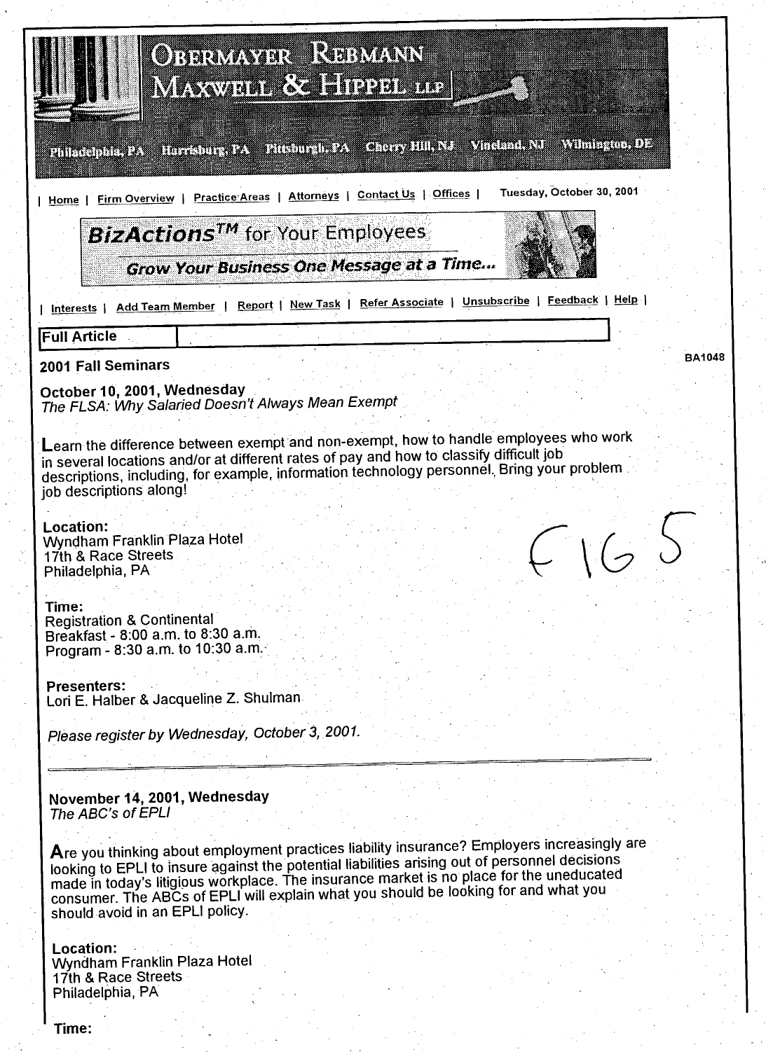

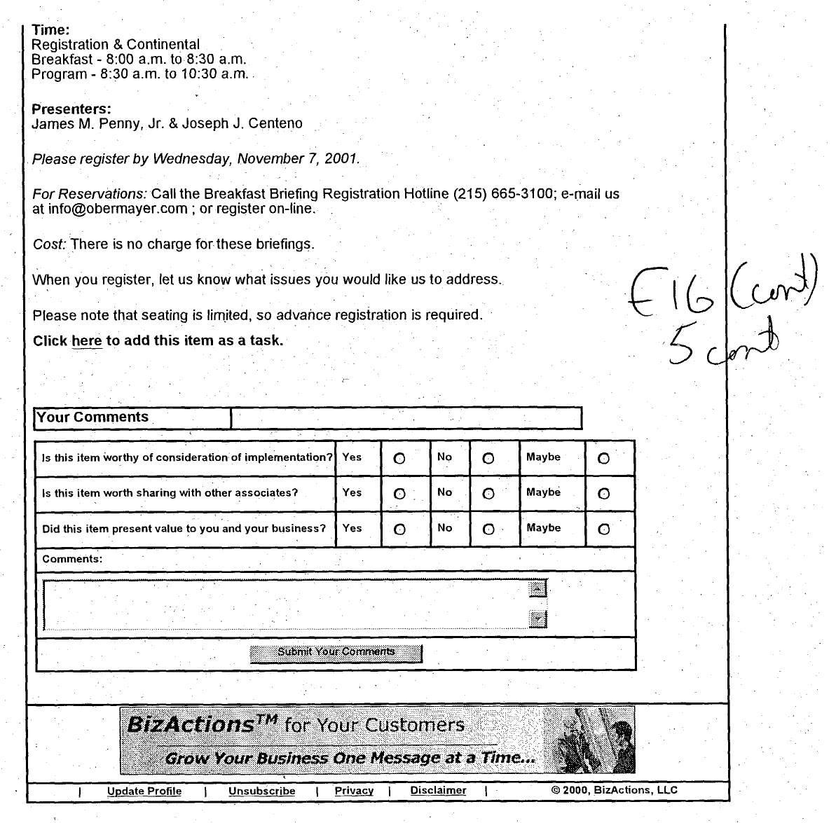

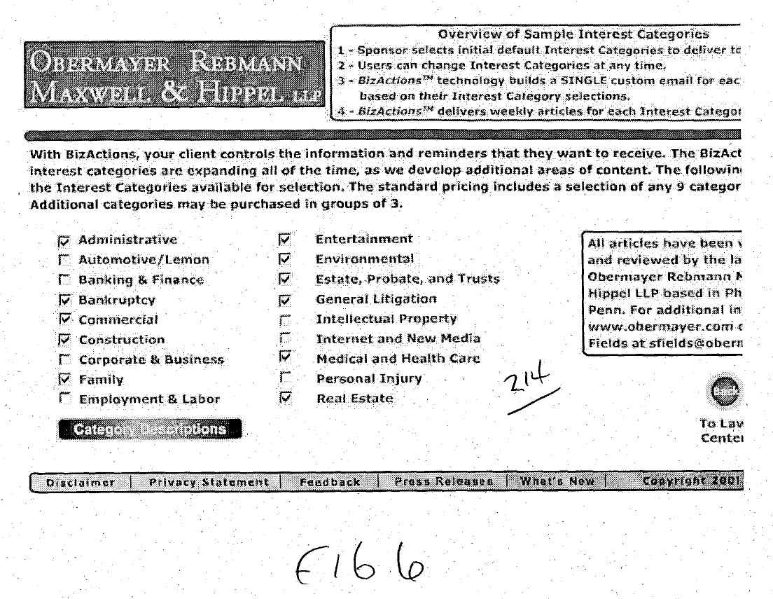

Referring to FIGS. 4 and 5, the email system of the present invention is now described in the context of the operational environment of FIGS. 1 to 3. The system is directed to the creation, editing and distribution of online email driven ezines and newsletters. The newsletter generated in accordance with the present invention is shown as shown the newsletter has a number of features. The system can further provide integrated announcements and banner head campaigns. The newsletter comprises a plurality of choices including the main button on the website 200, announcements 202, a series of articles 204. Each article 204 has a task button 206 for the assignment of tasks and the preparation of task reports 209. FIG. 5 illustrates an announcement page. It is to be appreciated that a feature of the present invention permits announcement to be tailored according to the type of recipient. Thus announcements for a “sponsor's” prospects may be different than those for a client or referral service. The system also allows users to define the members of teams 207.

As will be discussed herein, the newsletter is typically generated via a partner entry page to be discussed below. The partner entry page permits the end user to select the type of content which the customer or end user will have the ability to see. It is to be noted that the present invention provides for exclusive relationships between a sponsor and an end user. The email newsletter itself is broken into a plurality of categories. The partner can select the types of content which will be presented to the end user.

The newsletter/e-zine of the present invention has, in one embodiment, four basic systems, each of which is designed to be an effective system for an organization to communicate with a client, prospects, and referral sources. In the most preferred embodiment, the system is a comprehensive contact management system. In one embodiment, the system is an advanced electronic marketing system that uses push technology with HTML, knowledge-based emails. In one embodiment, the invention produces a portable website with various containers of information.

As used in this application, the term container refers to a piece of information that has its own unique buttons and which represent a functionality related to an item. As shown in FIG. 4, the present invention may have the following containers. These include a custom toolbar 203 with special buttons that provide six links to a sponsors web page 205, an announcement section 202, the content items 204 and the task system. It is to be appreciated that the buttons, in one embodiment, may be customized and that the email contact point for a sponsor may also be customized.

The present invention may use a conventional sniffer software that enables it to determine whether the system of the recipient can accept HTML emails. The special email is automatically sent with a web address that merely clicks on to receive the mail. Because this email is linked to a special address on the web, the browser will be able to display all of the information in the same manner as if it were capable of receiving HTML.

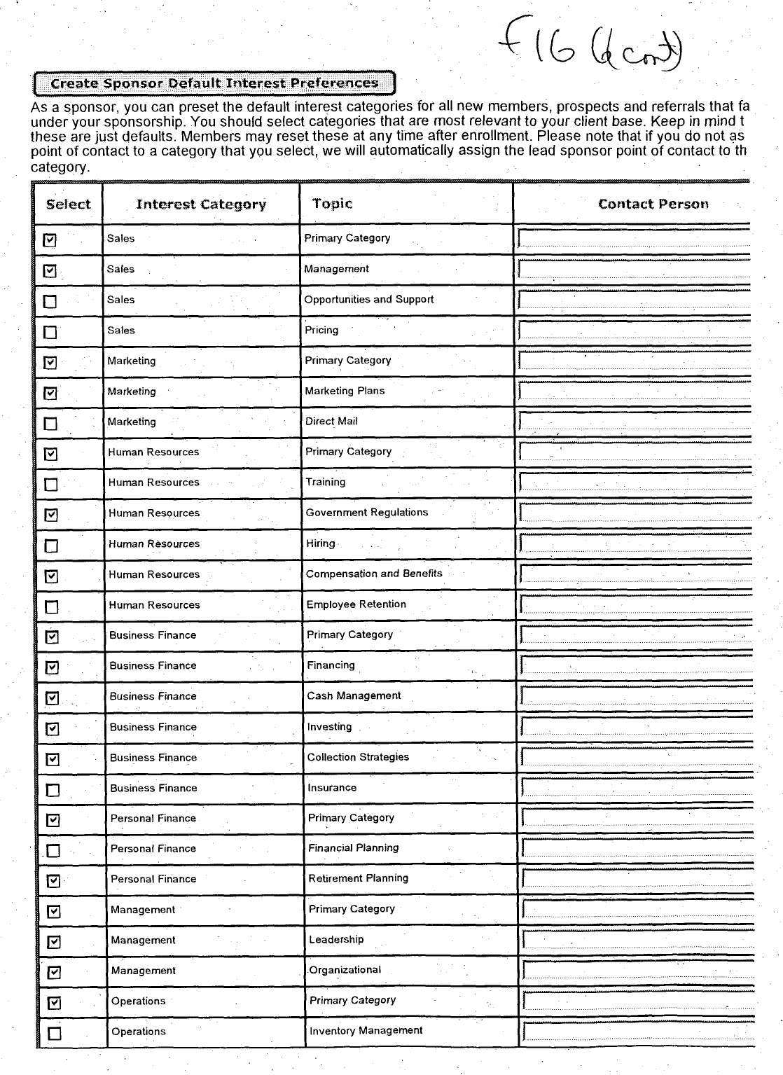

As shown in FIG. 6, the system incorporates a system 214 which lets the end user link to and select the interest categories of information they want to receive. As shown, this may comprise a plurality of areas of legal content. Alternatively, the system will comprise other content. The custom email may then be created for each user by combining multiple categories into one email. Users can convert each item of information into the reminder portion of the system. As shown, users can view and select resources and products that specifically relate to a particular item of information. Sponsors can communicate with their email list through the use of the announcement feature of the system.

It is also to be noted that the newsletters may be downloaded as an audio file such as in an MP3 file.

As shown in FIG. 4, sponsors or resource members can then utilize banner ads 211 that promote their products or services. Sponsors can also author their own items for use within the system. A response system for each content item back to the sponsor can be sent to the proper person. By significant reporting of click through activity, sponsors can analyze and manage the system.

As noted above, an interest category contains a series of articles that is selected by the user. The system is designed to manage content in many different categories of information.

Each category will typically comprise a major topic with subtopics. Examples of major topics include sales, marketing, human resources, business finances, personal finance, management, operations, technology, business tax and personal tax. The invention can be utilized to produce a plurality of category types. These include law, accounting, medicine or engineering.

When a sponsor starts utilizing the system, the initial email is based on a sponsor selected interest category. After the initial selection, the user is free to add or subtract categories by clicking on interest categories in the numbers section of the system as shown in FIG. 5.

Referring back to FIGS. 4 and 5, the system further provides the announcement container to allow a sponsor to send announcements to his email list. One of the critical features of the invention is that a different announcement can be sent to different users of the system. By using the announcement feature, the sponsor can save time and money in the communication with clients and prospects. The announcements will cover any type of information. Examples include seminar announcements, press releases, employee promotions, change of address mergers and acquisitions, new products, new services, special promotions, new employees, etc.

Announcements may be delivered to any user on an email sponsor's list. A sponsor can alternatively select or limit the group to whom announcements are sent. These selections will be available by type of email (that is client prospect and employee); category of email (industry, title, size of company); location of email (office, ownership, state, city or region). Each announcement has a number of elements. These include “more information” (unlimited space for the details of the announcement); a “contact me” automatic email back to the appropriate person in the sponsor's organization.

This email is pre-populated with the sender's contact information as well as details of the announcement. This sender can also add any comments or questions to the announcement. The system further contains a tasks section that provides the ability to convert the announcement into a task and/or forward it to a member of a team or non-team member.

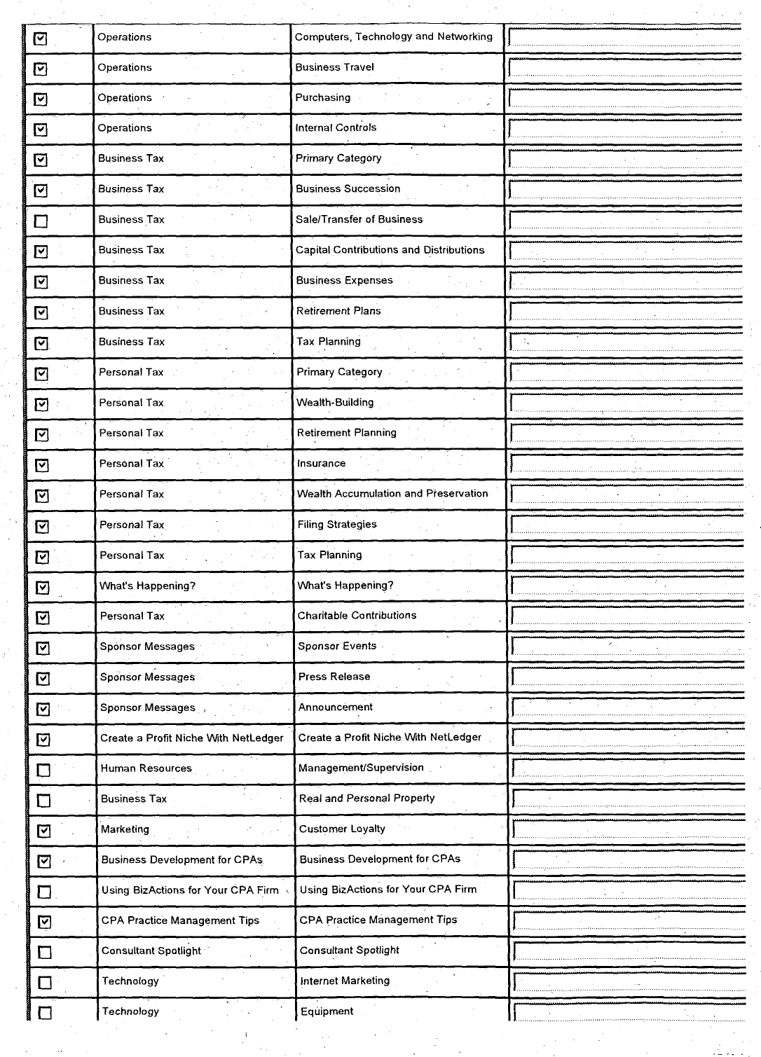

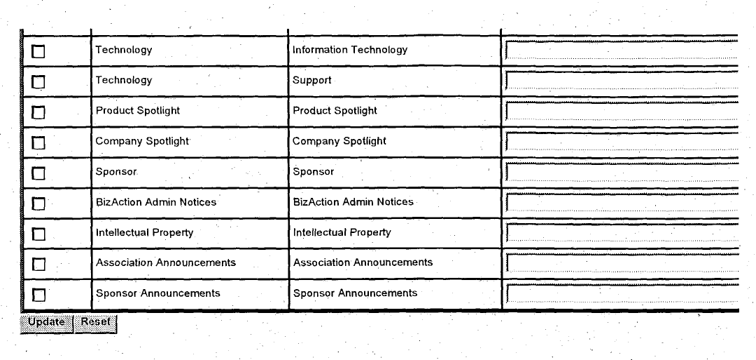

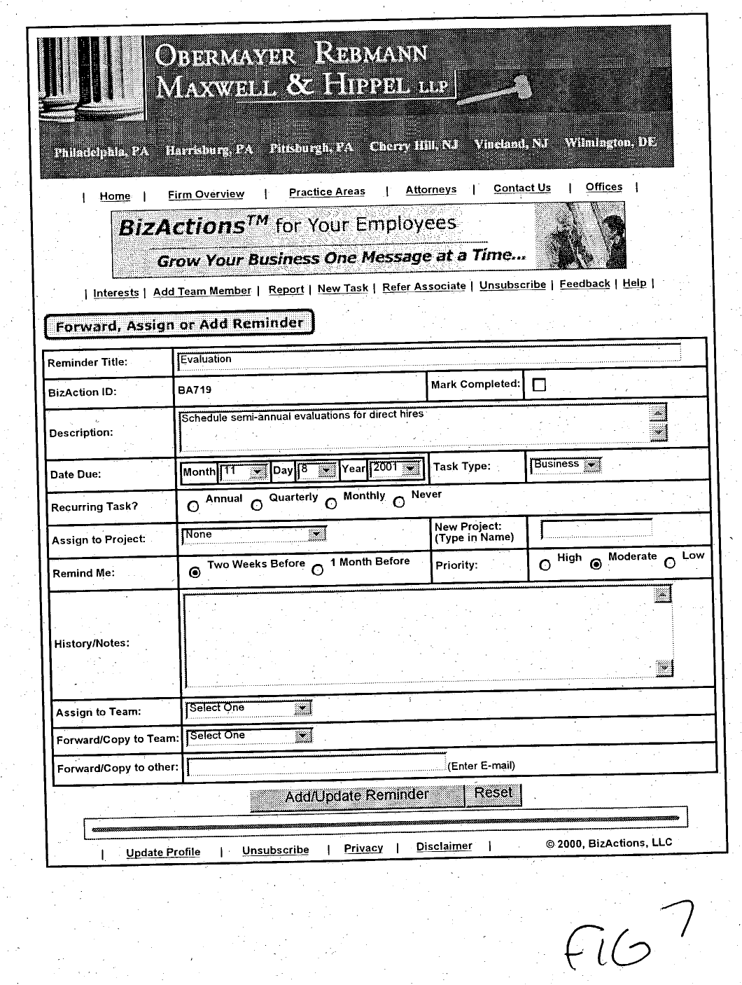

As noted above, a further feature of the present invention is the incorporation of a task system that allows a user an its organization to manage projects, teams and specific tasks of a user. This is shown in FIG. 7. Each article 204 can be automatically converted into a task and assigned to an individual with a due date. The task system is designed to assist the user in managing new ideas and facilitates the assignment of tasks to any member of a group. Any individual who is assigned a task has an email forward. The system further incorporates a “status of tasks to be reviewed” section which is available by clicking “reports” on the email button. Tasks are segregated between tasks that are completed and those that are not completed. Each column of information may be sorted separately. Because the report is available online, tasks can be managed anywhere that an internet connection exists. If the item is not completed, an email may be sent with the next email. FIG. 8 illustrates a comprehensive sheet which illustrates the status of open task items. A further related feature of the invention is a system which provides for the creation of “teams”. This allows a user to create a list of team members that can be assigned tasks. The system permits team members to be created within the organization or outside the company.

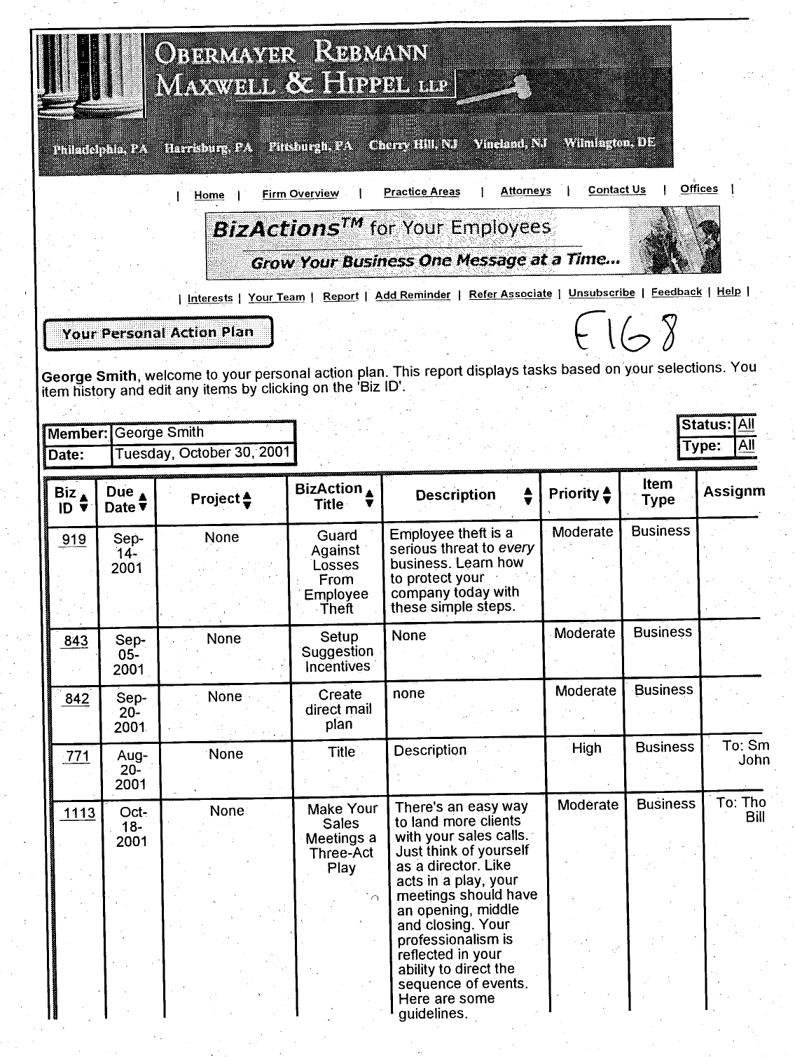

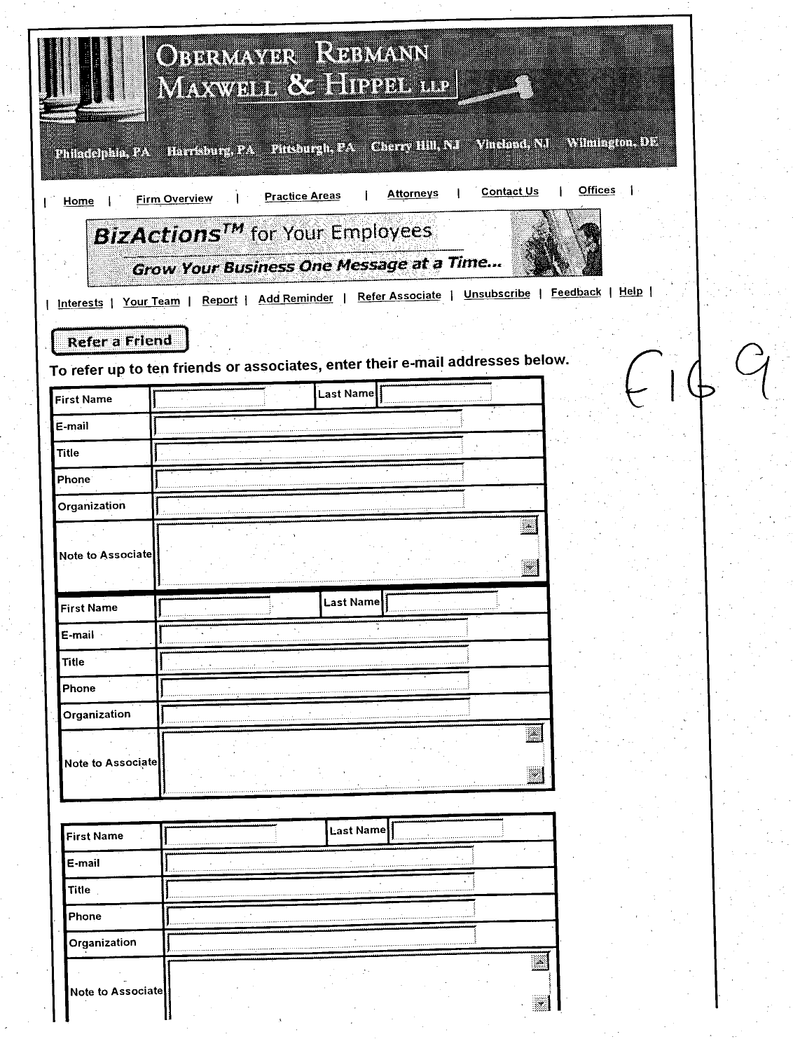

The system further incorporates a refer associate button 220 which when depressed provides a form shown in FIG. 9 so that the user has the ability to refer associates and friends to the system. A critical feature of the invention is an “unsubscribe” button 222 at the top and bottom of the main email that each form is invoked when buttons are pressed.

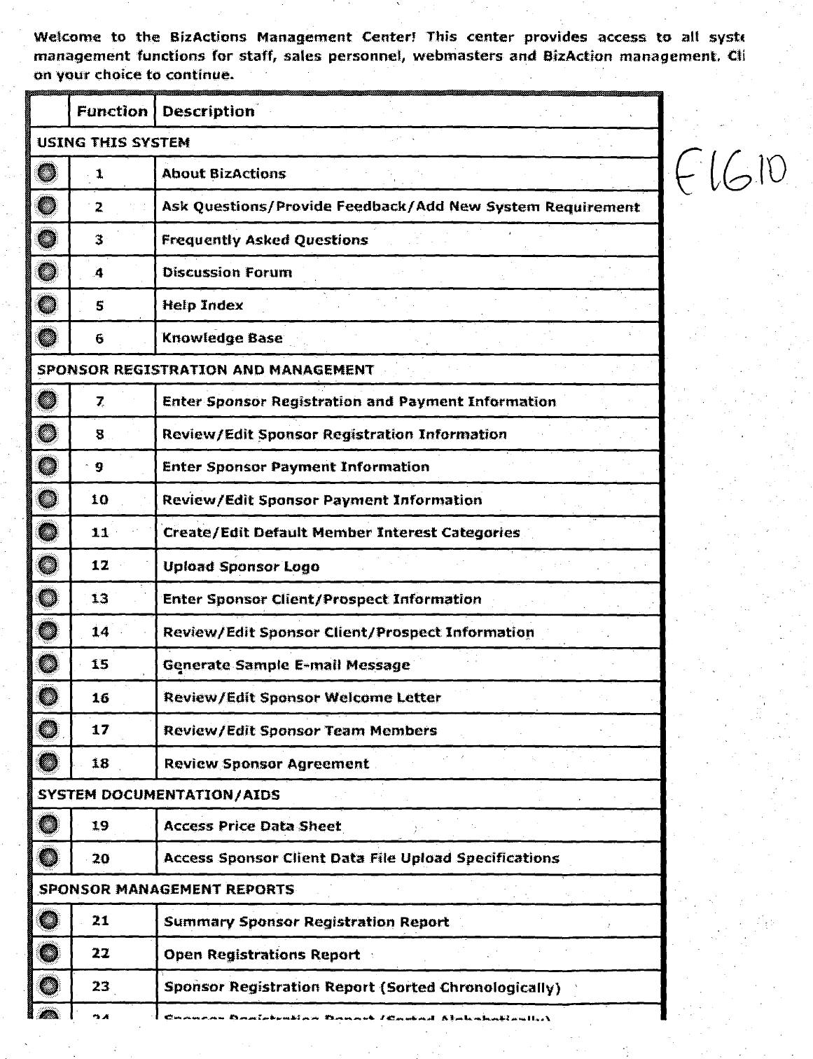

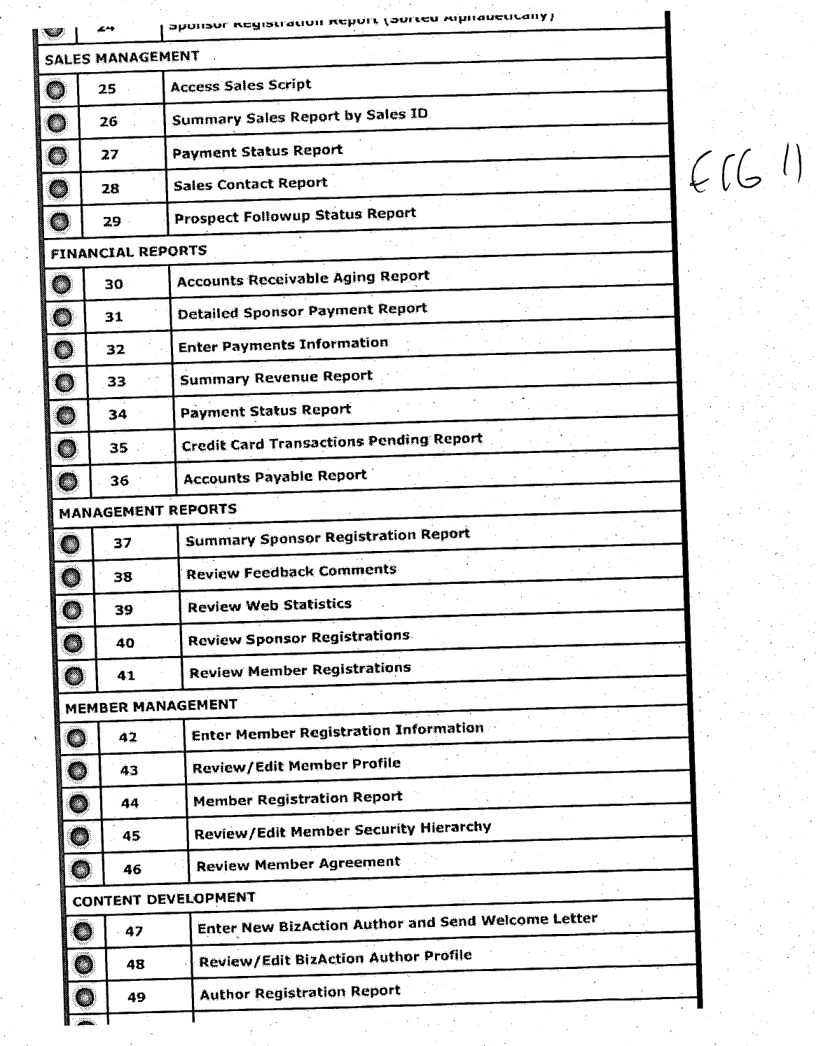

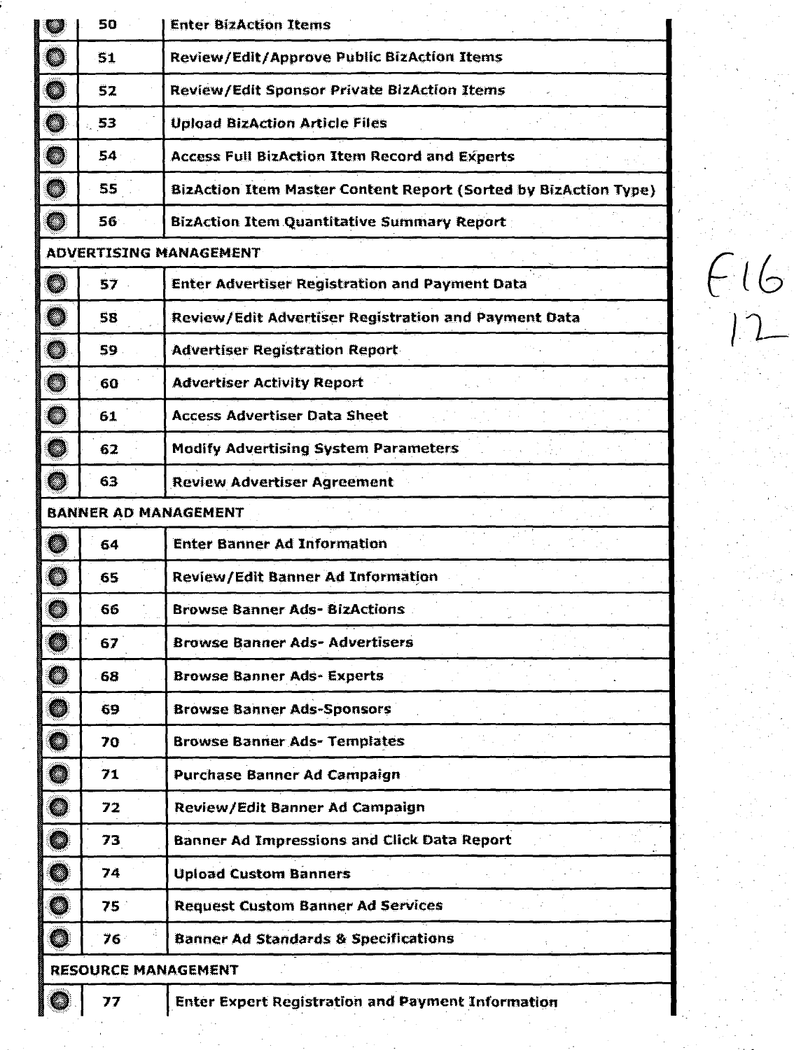

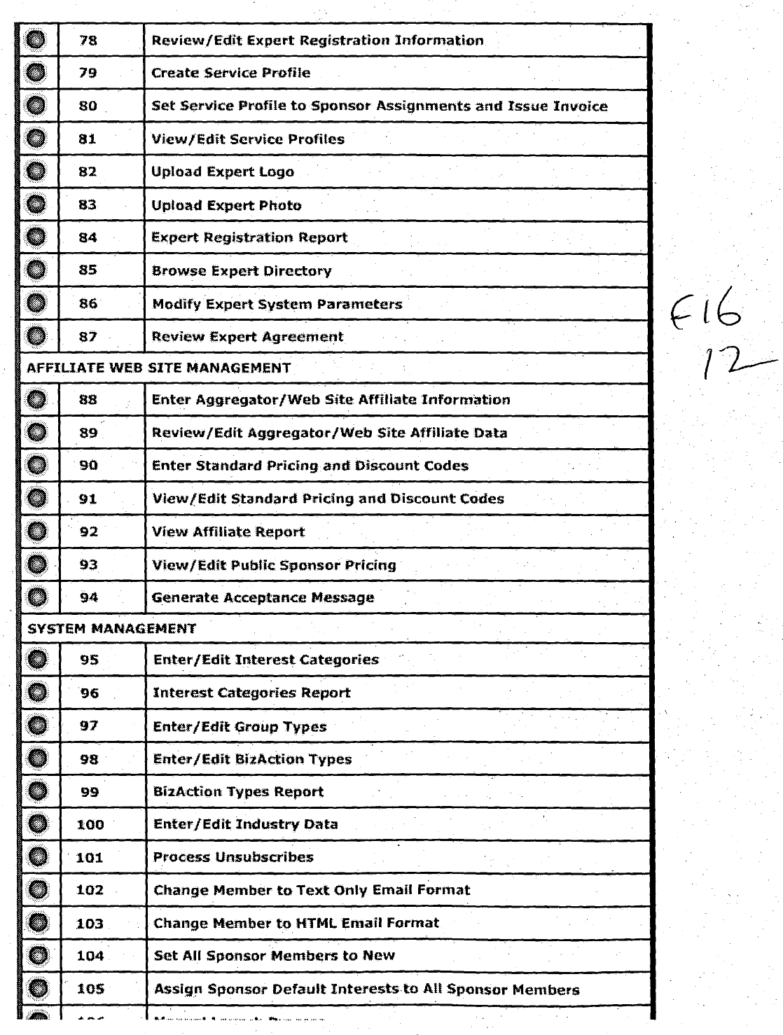

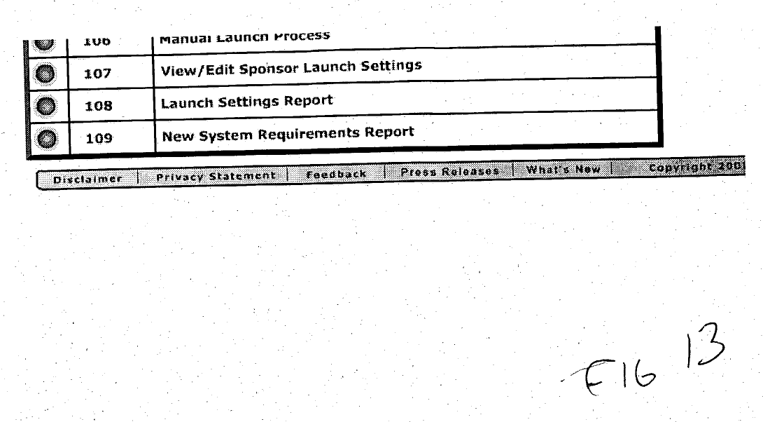

Referring now to FIGS. 10-13 the present invention incorporates detailed management reporting which is described herein and which are accessed via the administrative system 140. All reports provide summaries by reaching, office category and by contract person for any selected time period. Reports are then broken into categories including email activity, content activity and lead activity. The system further tracks the number of emails delivered by various categories, and tracks each time a user clicks on any button.

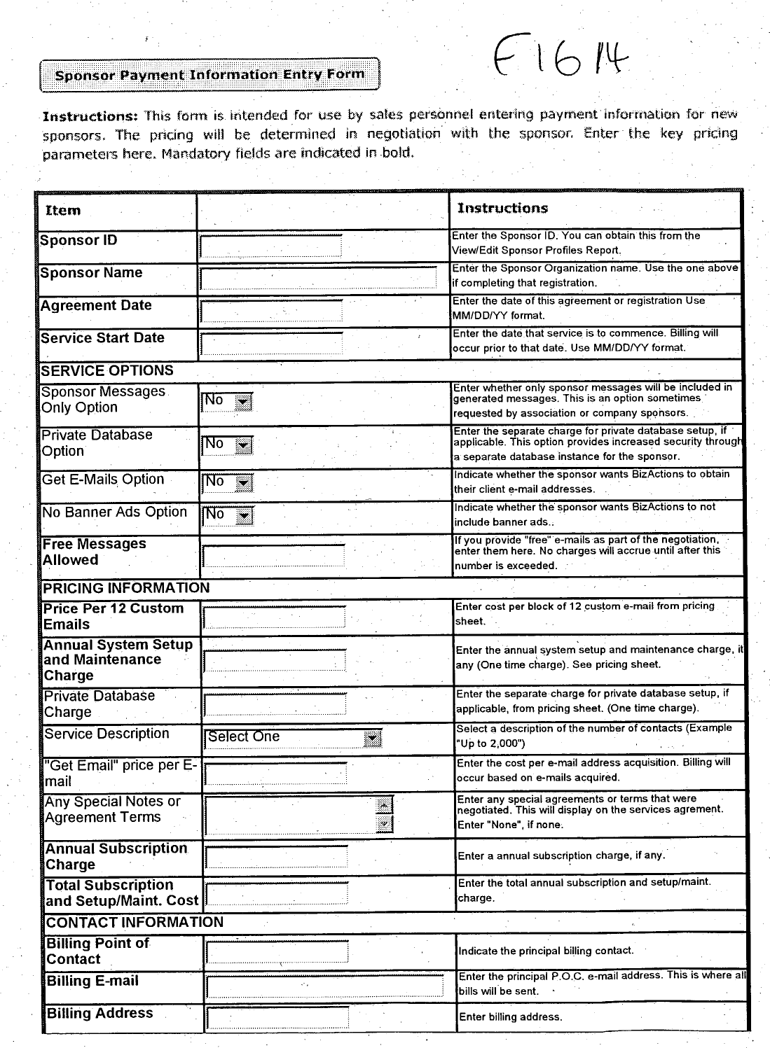

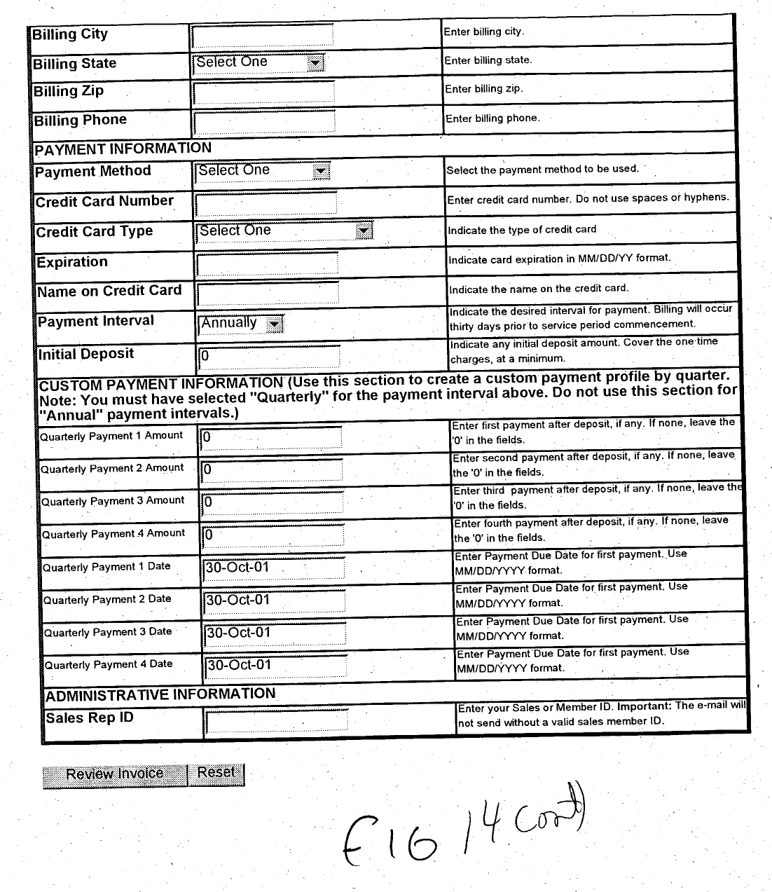

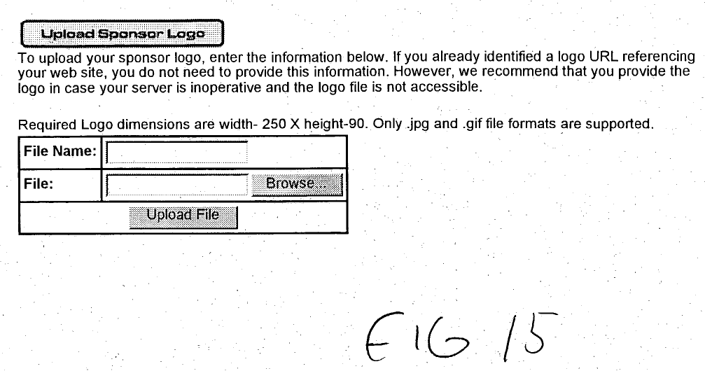

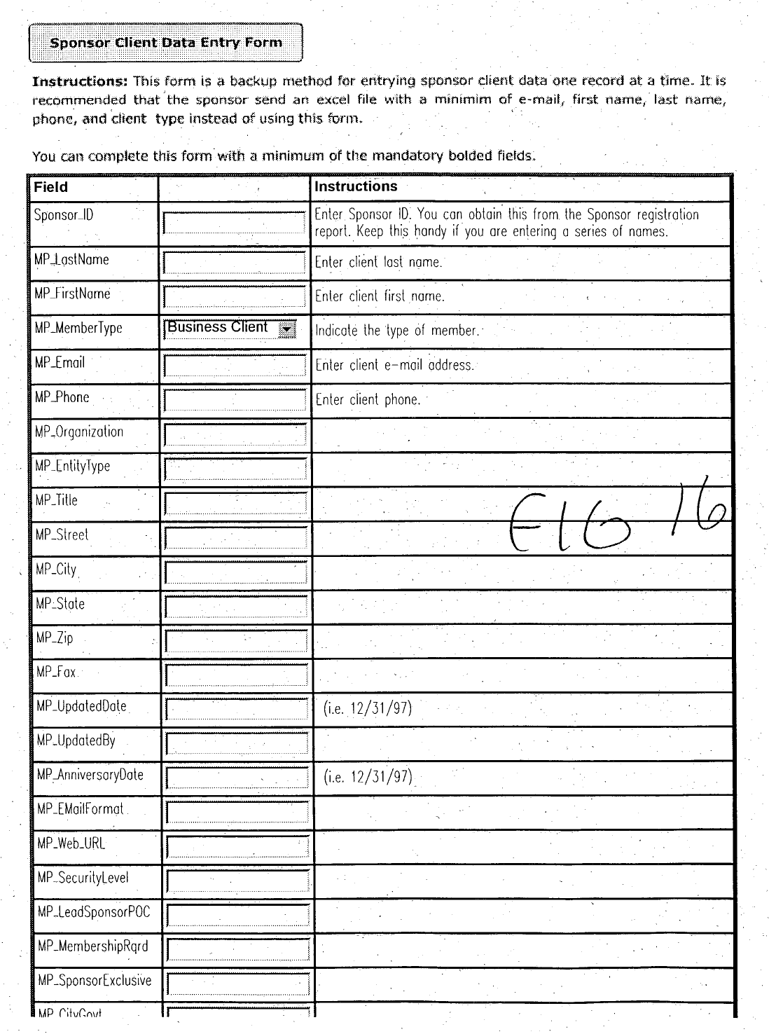

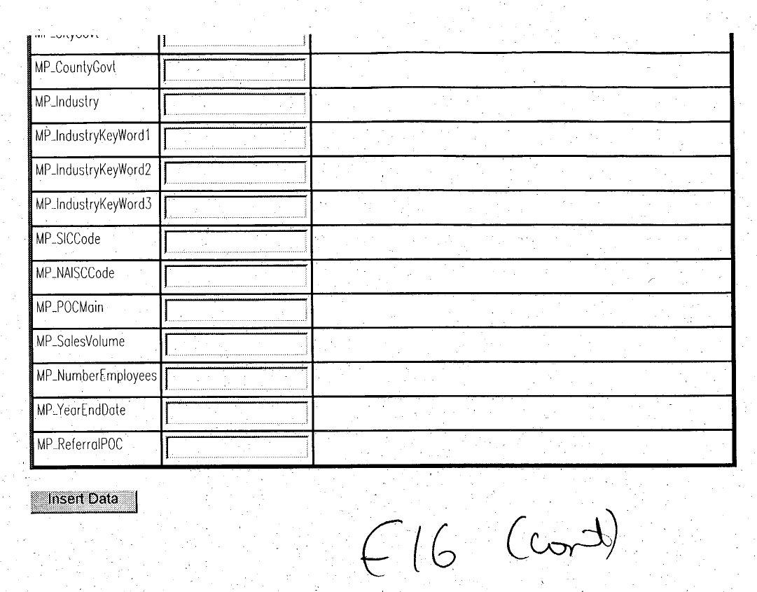

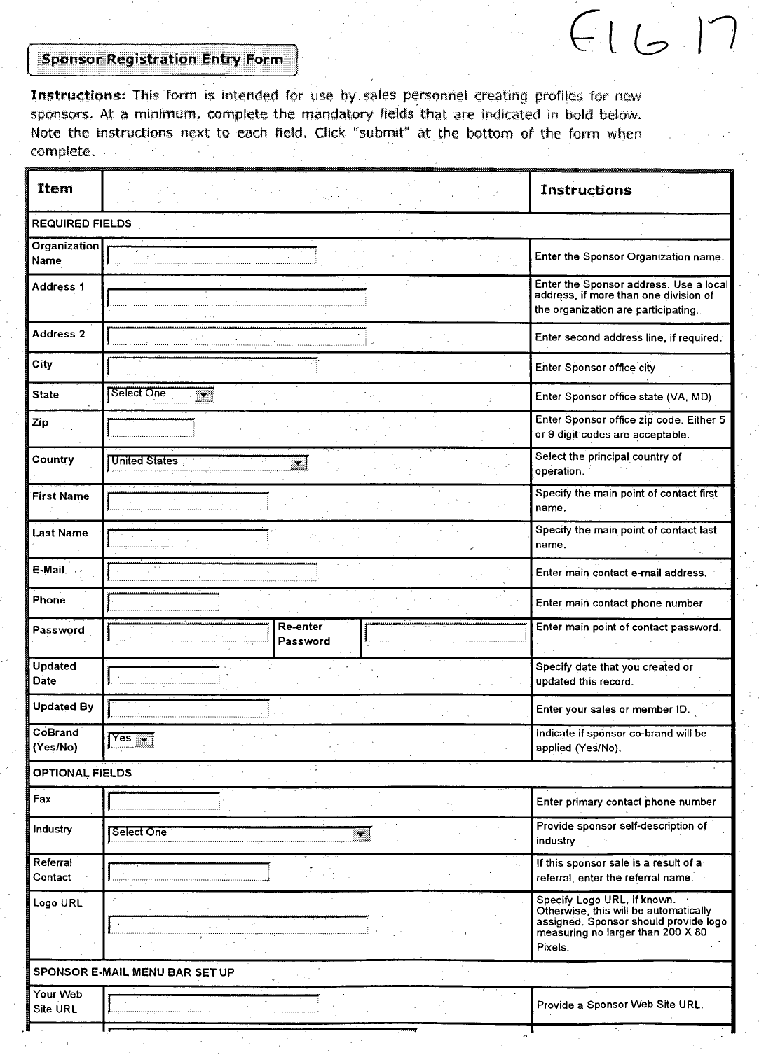

In one embodiment, the present invention incorporates a management system 240 which incorporates eleven sections. The first section incorporates basic background system 242 for monitoring FAQs a discussion forum and help knowledge base. The second section 244 relates to sponsor registration and management. This includes a sponsor registration 246 and payment information form 248 (FIG. 14), a record edit form 250, a form for creating a default list of categories for the system 254 (FIG. 15), a system for uploading a logo or gif 256 and a system for uploading sponsor client prospect information 258 and sponsor welcome letter and team letter. The system further incorporates system documentation aids including an access price data sheet and a sponsor client data upload system. FIGS. 16 and 17 comprise sponsor data entry forms.

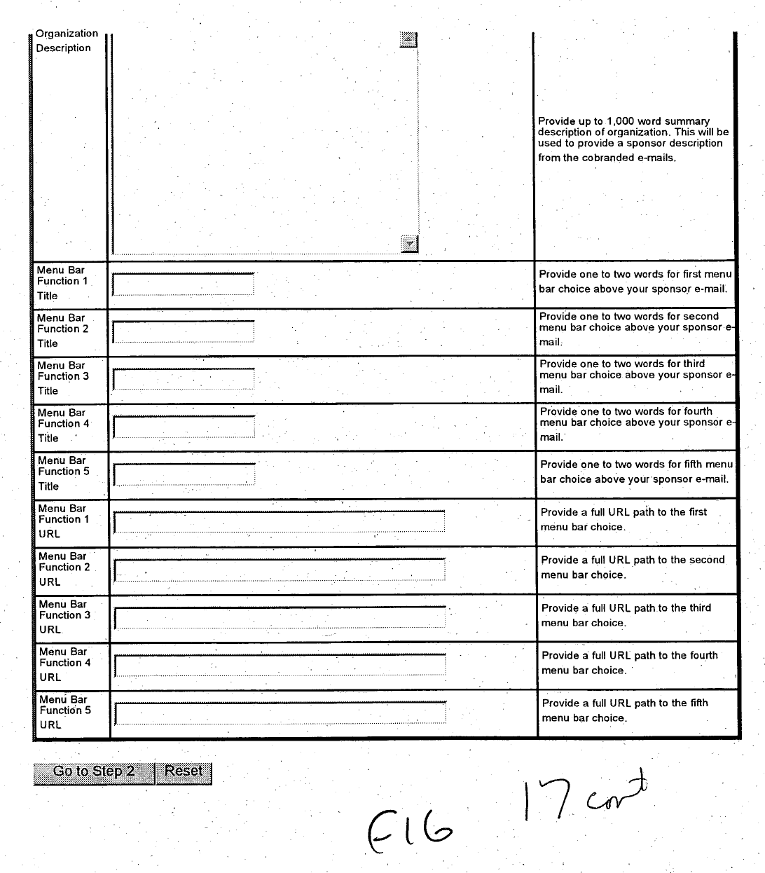

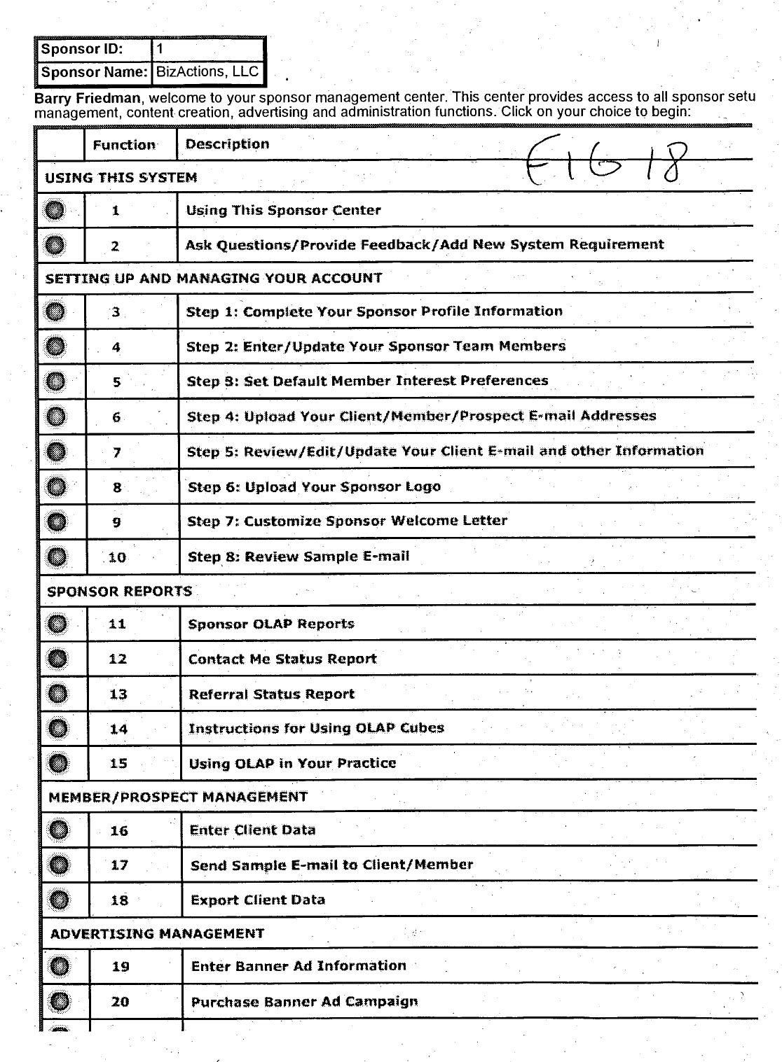

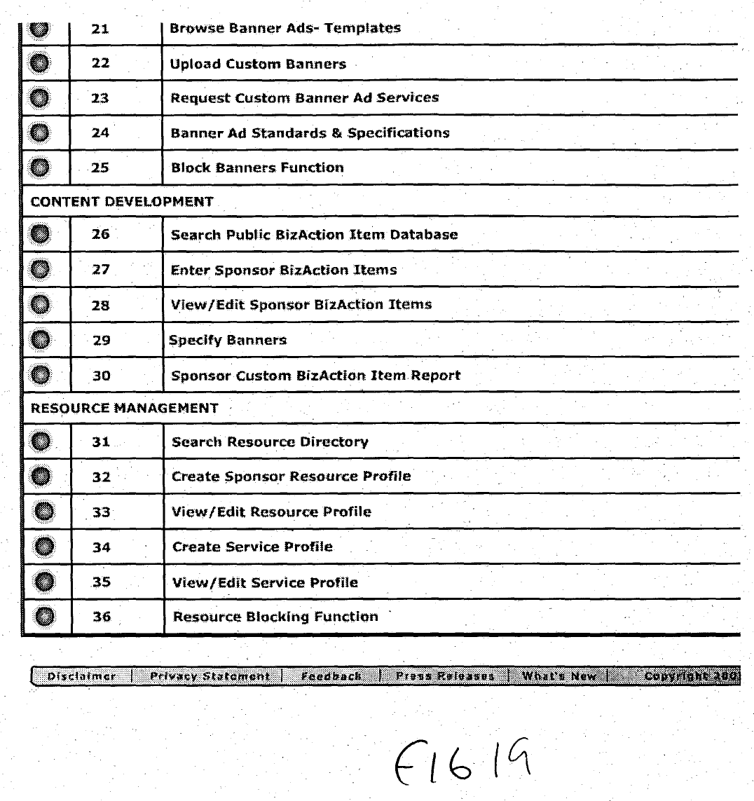

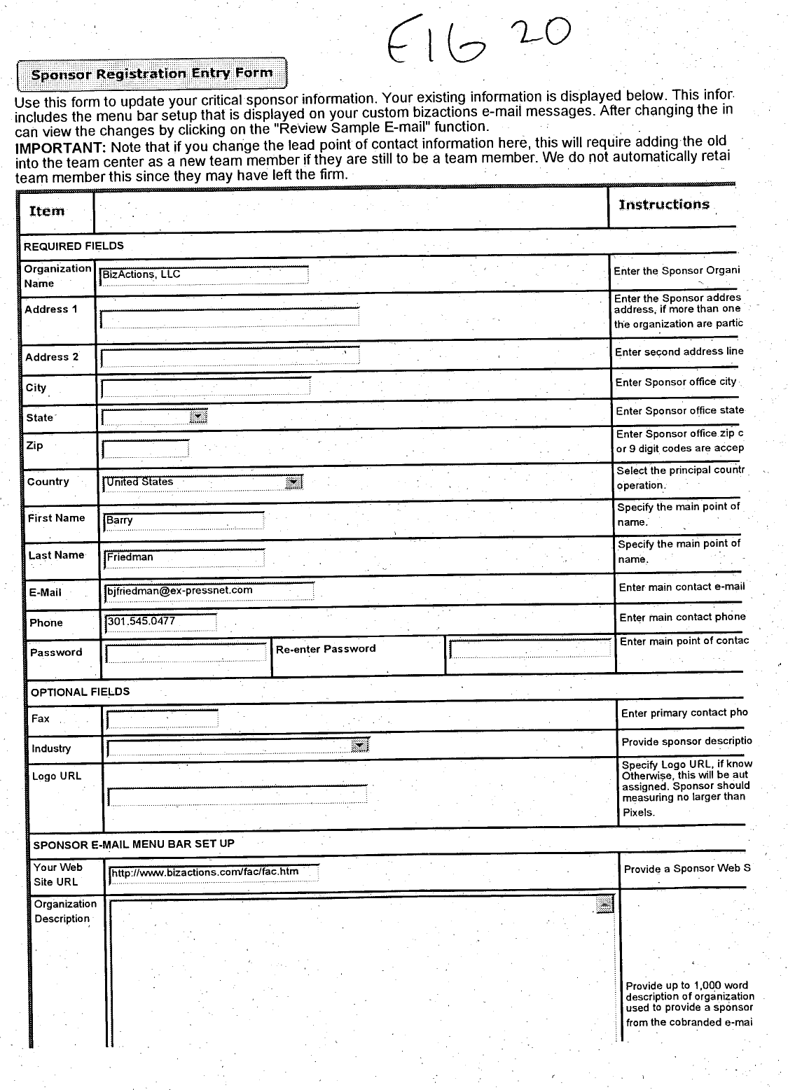

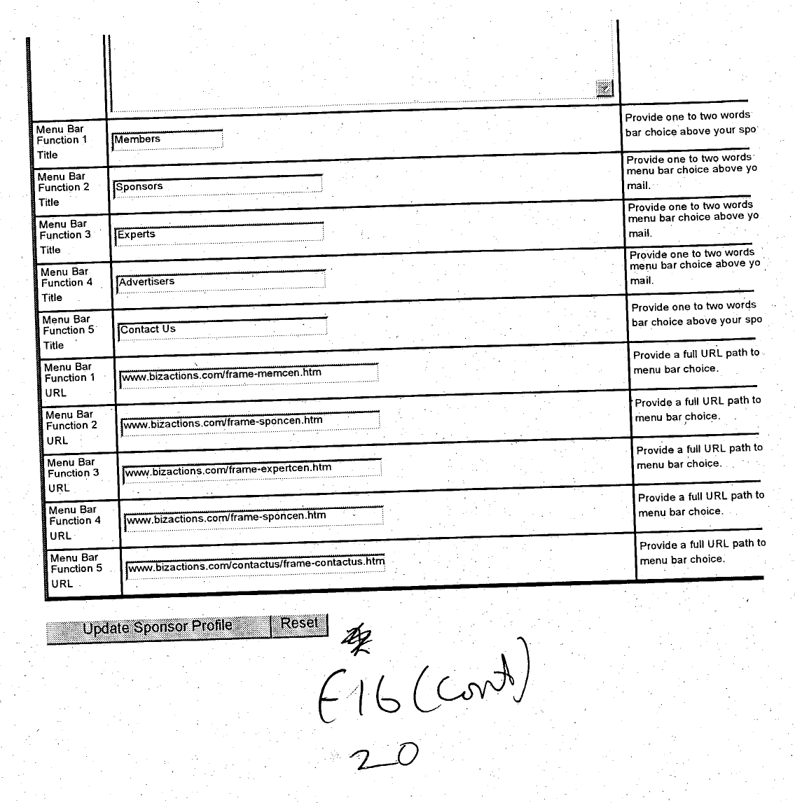

Referring to FIGS. 18-19, the system further incorporates a sponsor management system 260 which includes sponsor registration reports that can be sorted chronologically or alphabetically. The system further incorporates a series of sales, financial and management reports as well as a member registration system. The system further incorporates a module for content development 262 which is utilized to use create, edit, author and store articles and content. The content is then stored and can be accessed by users of the system.

The system also incorporates an advertising management system 270 and banner ad management system. The system also incorporates a resource management system in which various expert resources can be entered into the site. The sponsor center provides the sponsor with access to all functions necessary to set up and manage a sponsor account.

This permits the sponsor to set up a profile update, sponsor team members, set default member interest preferences aboard a logo, customize a sponsor welcome letter, and review sample email.

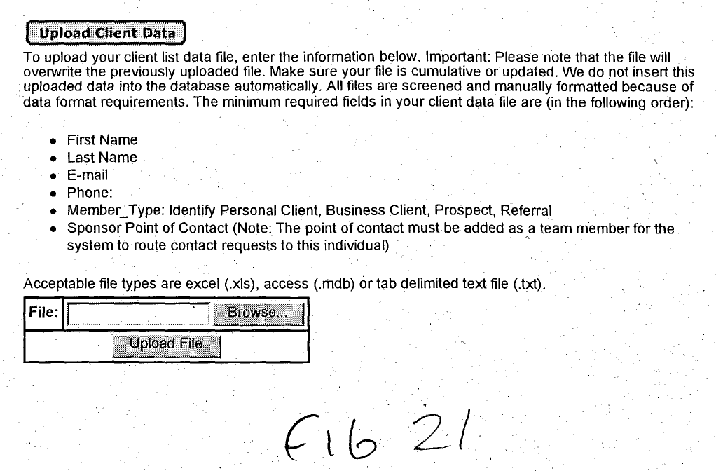

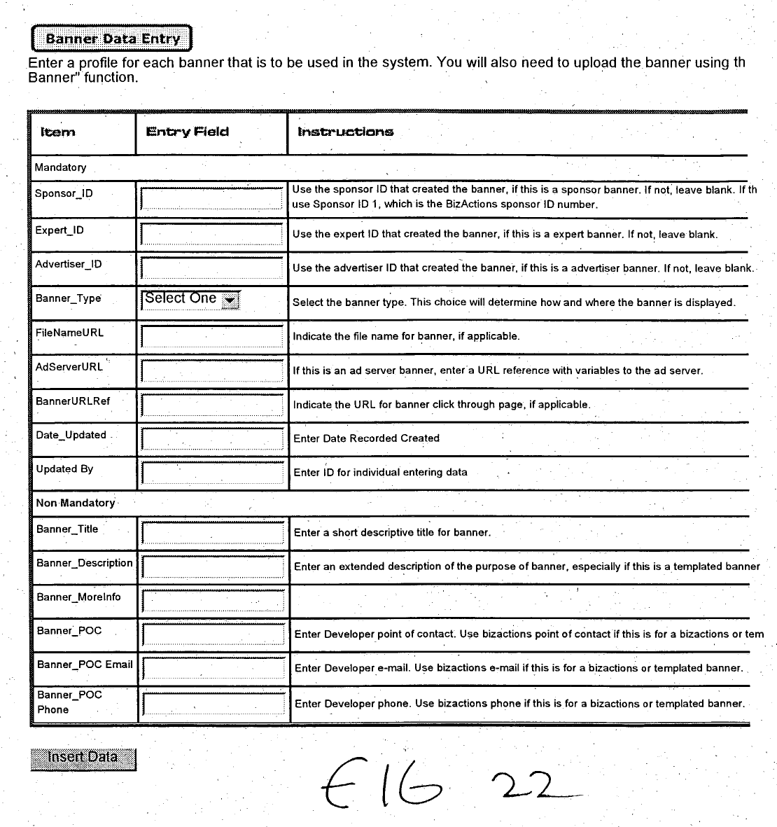

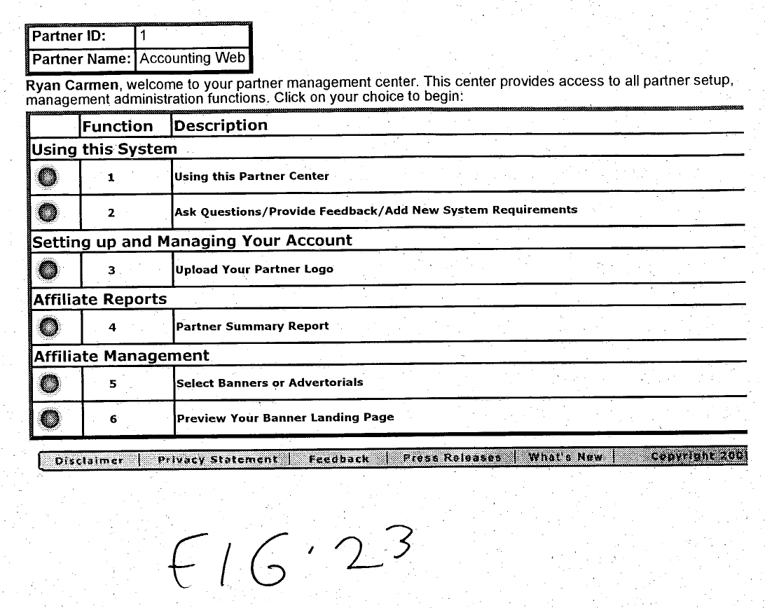

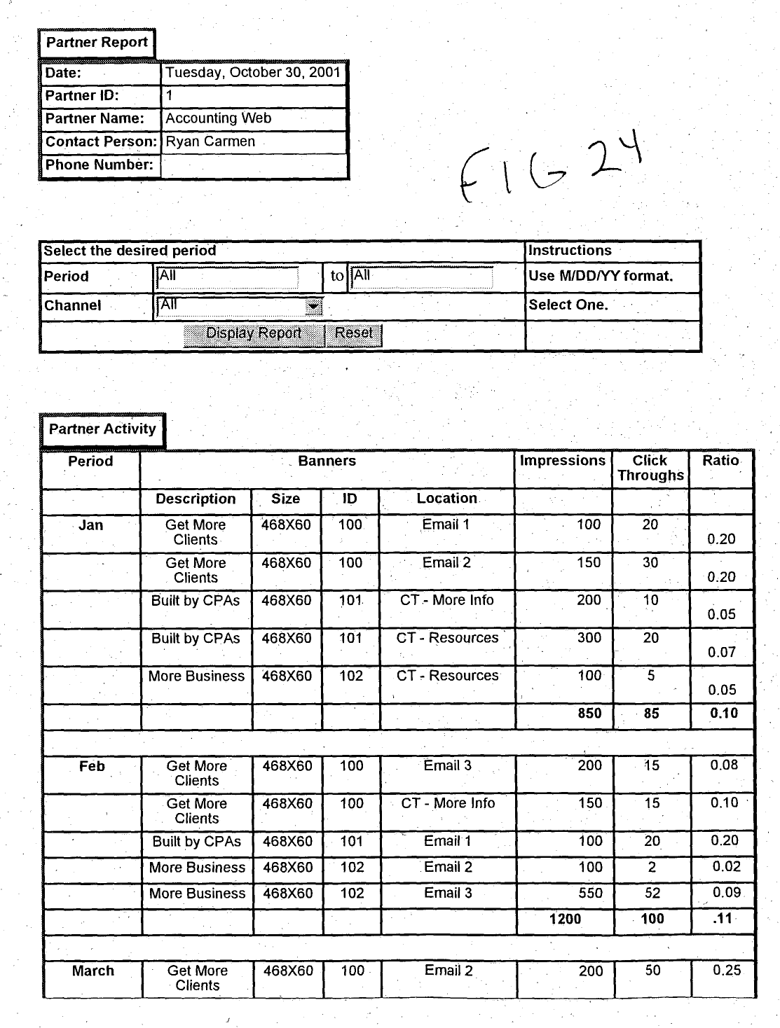

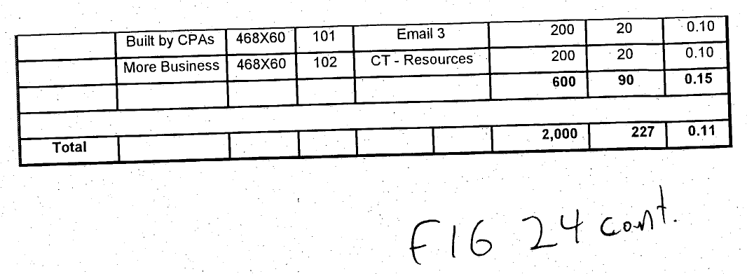

Finally, the system further incorporates a resource management system 280 which permits the creation and management of a search and resource directory. This directory may incorporate a number of links and resources. Finally, the system incorporates a partner center for providing partners access to all necessary functions to set up and manage their account. This system incorporates a means for setting up and managing an account, uploading a partner logo and creating a partner summary report and managing banners and advertiorals. FIGS. 21-24 illustrate a comprehensive system for monitoring and click-through.

The present invention has been described with reference to the enclosed figures and detailed description. It is to be appreciated that other embodiments fulfill the spirit and scope of the present invention and that the true nature and scope of the present invention is to be determined with reference to the attached claims.

1. A system for creating, editing and managing a communication between a prospective employer and prospective employee comprising:
a control unit for establishing a newsletter communication;
means for assisting an end user in formulating a newsletter request based upon the desires of the end user;
means for distributing the newsletter.

2. The system of claim 1 further comprising means for defining tasks by the end user based upon the content of the newsletter.

3. The system of claim 1 further comprising means for adding advertising to the newsletter.

4. A system for creating, editing and managing email newsletter communications in a specialty area between a sponsor and an end user:
a control unit for generating a newsletter based upon the inputs of the sponsor, said newsletter providing a plurality of content items;
means for emailing the newsletter to the end user;
means for permitting the end user to define new types of content the end user desires to receive;
means for the end user to define tasks within the system based upon the content of the newsletter; and
means for the end user to invite other end users to receive the newsletter.

5. The system of claim 4 wherein the specialty area comprises the accounting profession.

6. The system of claim 4 wherein the specialty area comprises a the legal profession.
